(19) United States
(12) Patent Application Publication
(10) Pub. No.: US 2025/0334294 A1
(43) Pub. Date: Oct. 30, 2025

(54) AIR-CONDITIONING OUTLET DEVICE

(71) Applicant: MORIROKU TECHNOLOGY COMPANY, LTD., Tokyo (JP)

(72) Inventors: Ryo Sakurai, Tokyo (JP); Mirei Uehara, Tokyo (JP)

(21) Appl. No.: 19/092,599

(22) Filed: Mar. 27, 2025

(30) Foreign Application Priority Data
Apr. 25, 2024 (JP) 2024-071191

(51) Int. Cl. F24F 13/12; F24F 13/072

(52) U.S. Cl. CPC F24F 13/12; F24F 13/072

(57) ABSTRACT

An air-conditioning outlet device includes a housing in which a blowout port is formed; a fin body provided inside the housing; and illumination units capable of illuminating a downstream end of the fin body. The downstream end of the fin body serves as an ornament that is decorated and that is illuminated by the illumination units. The fin body is located upstream of the blowout port and substantially at a central position in a second direction in a normal mode to allow air to be blown, and by being displaced from a position in the normal mode toward an upstream side, the fin body blocks a part of a flow path to set an air-blowing stop mode in which air blowing is prevented.

### FIELD OF THE INVENTION

The present invention relates to an air-conditioning outlet device.

### BACKGROUND

As a conventional technique related to an air-conditioning outlet device used in vehicles, there is a technique disclosed in Japanese Unexamined Patent Publication No. H10-250356.

An air-conditioning outlet device as disclosed in Japanese Unexamined Patent Publication No. H10-250356 includes a housing in which a blowout port is formed at a downstream end, and a switching unit that is rotatably provided in the vicinity of the blowout port and that switches between an air-blowing mode and an air-blowing stop mode.

The switching unit includes an opening through which air can pass, and a blocking that blocks the flow of the air. By rotating the switching unit, the opening or the blocking is made to face the blowout port, and switching can be performed between the air-blowing mode and the air-blowing stop mode. A surface on a passenger compartment side of the blocking is decorated, and the design is improved.

### SUMMARY

According to the air-conditioning outlet device disclosed in Japanese Unexamined Patent Publication No. H10-250356, since the decorated blocking portion faces the interior of a passenger compartment during the stoppage of air blowing, good design is provided. Meanwhile, during air blowing, the blocking portion is not visible from inside the passenger compartment, and the design quality declines. There is room for improvement in this regard.

According to the present disclosure, there is provided an air-conditioning outlet device including: a housing into which air is blown, and in which a blowout port that blows out the air is formed at a downstream end with respect to a flow direction of the blown air; a fin body displaceably provided inside the housing; and illumination units capable of illuminating a downstream end of the fin body. The downstream end of the fin body serves as an ornament that is decorated and that is illuminated by the illumination units. The blowout port has a substantially rectangular shape. When a direction parallel to long sides of the blowout port is defined as a first direction and a direction parallel to short sides that are sides shorter than the long sides is defined as a second direction, the fin body is provided along the first direction and is located upstream of the blowout port and substantially at a central position in the second direction in a normal mode to allow the air to be blown, and by being displaced from a position in the normal mode toward an upstream side, the fin body blocks a part of a flow path to set an air-blowing stop mode in which air blowing is prevented.

According to the present disclosure, it is possible to provide the air-conditioning outlet device with good design.

### BRIEF DESCRIPTION OF THE DRAWINGS

FIG. 1 is a perspective view of an air-conditioning outlet device according to an embodiment as viewed obliquely from above;

FIG. 2 is a cross-sectional view taken along line 2-2 in FIG. 1;

FIG. 3 is a view schematically illustrating a second fin mechanism illustrated in FIG. 1;

FIG. 4 is a view for describing an air-blowing stop mode of the air-conditioning outlet device illustrated in FIG. 2; and

FIG. 5A is a view for describing a pattern of a fin body in a normal mode, and FIG. 5B is a view for describing a pattern of the fin body in the air-blowing stop mode.

### DETAILED DESCRIPTION

An embodiment of the invention will be described below with reference to the accompanying drawings. A mode illustrated in the accompanying drawings is one example of the invention, and the invention is not limited to the mode.

### Embodiment

An embodiment will be described with reference to the drawings.

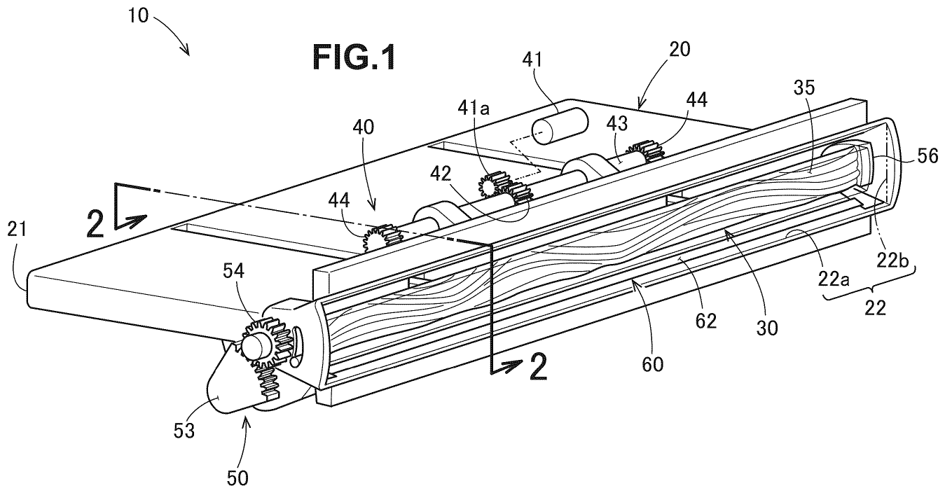

Referring to FIG. 1, an air-conditioning outlet device 10 is used as a outlet device for an air conditioner for a vehicle. The air-conditioning outlet device 10 is provided, for example, in a front portion of a passenger compartment, and blows air toward occupants.

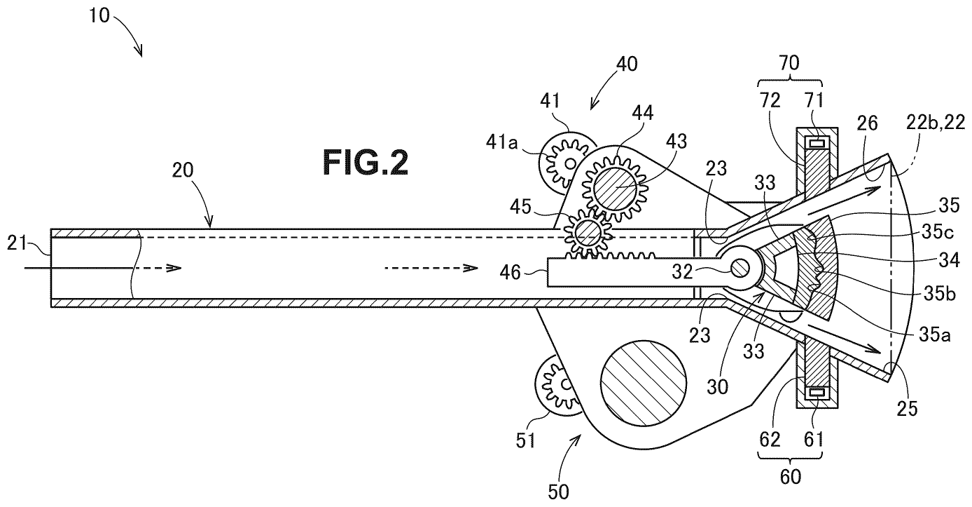

The air-conditioning outlet device 10 includes a housing 20 into which air is blown; a fin body 30 provided inside the housing 20; a first fin mechanism 40 that displaces the fin body 30 along an air blowing direction; a second fin mechanism 50 that swings the fin body 30 in an up-down direction (a direction parallel to the short sides of a blowout port); and illumination units 60 and 70 capable of illuminating a downstream end of the fin body 30 (see FIG. 2 for the illumination unit 70).

Referring to FIG. 2, the housing 20 includes an introduction port 21 through which the blown air is introduced; a blowout port 22 that faces the interior of the passenger compartment, and that blows out the air toward the passenger compartment; a narrow portion 23 formed between the introduction port 21 and the blowout port 22 and having an area smaller than the area of the blowout port 22; and inner walls 25 and 26 extending substantially parallel to upper and lower surfaces of the fin body 30 from the narrow portion 23 to the blowout port 22.

Referring to FIG. 1, the blowout port 22 has a substantially rectangular shape. Hereinafter, a direction parallel to long sides 22a of the blowout port 22 (a vehicle width direction in the present embodiment) is referred to as a first direction, and a direction parallel to short sides 22b that are sides shorter than the long sides 22a (the up-down direction in the present embodiment) is referred to as a second direction.

In the case of the air-conditioning outlet device 10 in which the blowout port 22 is long up and down, the first direction is the up-down direction, and the second direction is the vehicle width direction (and/or a vehicle front-rear direction). In addition, the first direction may be the vehicle front-rear direction, and the second direction may be the up-down direction (or the vehicle width direction).

The fin body 30 is provided along the first direction.

Referring to FIG. 2, in a normal mode, the fin body 30 is located between the narrow portion 23 and the blowout port 22 and substantially at the center of the blowout port 22 with respect to the second direction. The fin body 30 has a shape in which a substantially fan-shaped cross-section extends in the first direction. The fin body 30 includes a fin body pin 32 that is a pin formed at an upstream end of the fin body 30, and that is connected to the first fin mechanism 40; tapered portions 33 and 33 extending downstream from the fin body pin 32 so as to widen; a connecting portion 34 formed in an arc shape so as to connect downstream ends of the tapered portions 33 and 33; and an ornament 35 overlapping the connecting portion 34 and illuminated by the illumination units 60 and 70.

The connecting portion 34 is illustrated as having an arc shape, but may be formed linearly. In addition, the tapered portions 33 and the connecting portion 34 may be a single integrated member.

The ornament 35 is composed of, for example, a transparent member made of acrylic, glass, or the like. The ornament 35 includes a plurality of uneven portions 35a to 35c formed in an uneven shape on a surface of the ornament 35 that faces the connecting portion 34. The uneven portions 35a to 35c have different depths at their deepest places. In addition, the uneven portions 35a to 35c are formed intermittently in the first direction and the second direction, and change in depth.

The uneven portions 35a to 35c may be formed on a front surface of the ornament 35, and in this case, the uneven portions 35a to 35c may not be formed on the surface of the ornament 35 that faces the connecting portion 34.

The ornament 35 may be a smoky semi-transparent material. In addition, the depths or shapes of the plurality of uneven portions 35a to 35c may be uniform.

Referring to FIG. 1, the first fin mechanism 40 includes, for example, a first motor 41 which is a stepping motor that operates when energized; a 1-1 gear 42 which is a gear that rotates when the first motor 41 is operated; a first shaft 43 that is a shaft penetrating through the 1-1 gear 42 and rotatably supported by the housing 20; 1-2 gears 44 that are gears fixed to both ends of the first shaft 43, and that rotate when the 1-1 gear 42 rotates.

Referring to FIG. 2, the first fin mechanism 40 further includes 1-3 gears 45 that gears meshing with the 1-2 gears 44, and racks 46 that mesh with the 1-3 gears 45 and convert a rotational motion into a linear motion. The rack 46 is connected to the fin body 30. The fin body 30 is swingably connected to the rack 46.

Referring to FIG. 1, a gear provided on the first motor 41 is referred to as a first drive gear 41a for transmitting the driving force of the first motor 41.

A motor other than a stepping motor can be used as the first motor 41. In addition, the gears 42, 44, and 45 (see FIG. 2 for the 1-3 gear 45) that transmit the driving force of the first motor 41 to the racks 46 may be composed of one or two gears, or may be composed of four or more gears.

Referring also to FIG. 2, when the first motor 41 is operated based on information from a temperature sensor or an operation by an occupant, the 1-1 gear 42, the first shaft 43, the 1-2 gears 44, and the 1-3 gears 45 rotate. Accordingly, the racks 46 are displaced along the air blowing direction, and the fin body 30 is displaced along the air blowing direction. In other words, the fin body 30 is displaced along the flow path.

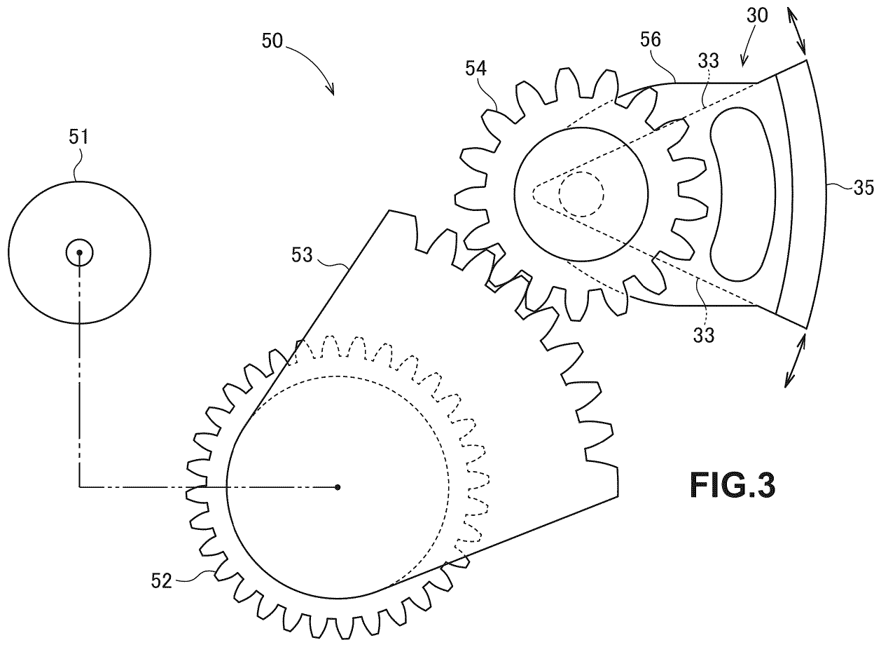

Referring to FIG. 3, the second fin mechanism 50 includes, for example, a second motor 51 which is a stepping motor that operates when energized; a 2-1 gear 52 which is a gear that rotates when the second motor 51 is operated; fan-shaped gears 53 which are fan-shaped gears that rotate when the 2-1 gear 52 rotates; 2-2 gears 54 that mesh with the fan-shaped gears 53, and that rotate when the fan-shaped gears 53 rotate; and fin supports 56 that are rotatable in conjunction with the 2-2 gears 54, and that can support the fin body 30.

A motor other than a stepping motor can be used as the second motor 51. In addition, the gears 52 to 54 that transmit the driving force of the second motor 51 to the fin supports 56 may be composed of one or two gears, or may be composed of four or more gears. In addition, the fan-shaped gears may not be included.

The fin supports 56 are connected to the fin body 30 in the normal mode, and are offset from the fin body 30 in an air-blowing stop mode. In other words, the fin body 30 is provided to be displaceable with respect to the fin supports 56 such that the fin body 30 is connected to the fin supports 56 in the normal mode, and is separated from the fin supports 56 in the air-blowing stop mode.

When the second motor 51 is operated based on information from the temperature sensor or an operation by an occupant, the 2-1 gear 52, the fan-shaped gears 53, the 2-2 gears 54, and the fin supports 56 rotate. When the fin body 30 is in the normal mode in which air can be blown, the fin body 30 swings in the second direction, together with the fin supports 56.

The second fin mechanism 50 may be any mechanism capable of displacing the fin body 30 in the second direction. Namely, the second fin mechanism 50 may be a mechanism that moves the fin body 30 linearly in the second direction.

Referring to FIG. 2, the illumination units 60 and 70 are provided both above and below the fin body 30. When the fin body 30 is displaced in a direction along the flow path and in the second direction, at least one of the illumination units 60 and 70 always illuminates the ornament 35. Hereinafter, the illumination unit 60 located below the fin body 30 is referred to as a lower illumination unit 60, and the illumination unit 70 located above the fin body 30 is referred to as an upper illumination unit 70. The illumination units 60 and 70 are provided to be flush with the inner walls 25 and 26, and do not protrude toward a flow path side.

The illumination units 60 and 70 do not necessarily need to be provided on both upper and lower sides. The illumination unit may be provided only on either the upper or lower side of the fin body 30.

The lower illumination unit 60 includes a light source 61 that is turned on when energized, and a light guide 62 that guides light from the light source 61 toward the ornament 35. The light guide 62 is provided to face the entirety of the fin body 30 along the first direction. A portion of the inner wall 25 that faces a tip of the light guide 62 is open. The position of the light source 61 and the shape of the light guide 62 can be changed as appropriate depending on the illumination position and the illumination range.

The configuration of the upper illumination unit 70 is the same as the configuration of the lower illumination unit 60. The upper illumination unit 70 includes a light source 71 that is turned on when energized, and a light guide 72 that guides light from the light source 71 toward the ornament 35. The light guide 72 is provided to face the entirety of the fin body 30 along the first direction. A portion of the inner wall 26 that faces a tip of the light guide 72 is open. The position of the light source 71 and the shape of the light guide 72 can be changed as appropriate depending on the illumination position and the illumination range.

For example, LEDs can be used as the light sources 61 and 71. In addition, the light guides 62 and 72 can be made of, for example, acrylic.

Next, actions of the air-conditioning outlet device 10 will be described.

FIG. 2 illustrates the air-conditioning outlet device 10 in the normal mode. In the normal mode, the fin body 30 is located between the narrow portion 23 and the blowout port 22 and substantially in the middle of the flow path with respect to the second direction. In the normal mode, the air blown from an air conditioner (not illustrated) is divided into upper and lower airflows by the fin body 30, and is blown out upward and downward from the blowout port 22.

The two divided airflows are blown out upward and downward from the blowout port 22, namely, in directions away from each other; however, since the air pressure in a central region (downstream of the ornament 35) interposed between the two airflows decreases, portions of the two airflows are drawn into the central region and are bent to approach each other. Therefore, the air spreads and can be blown over a wide range including the central region.

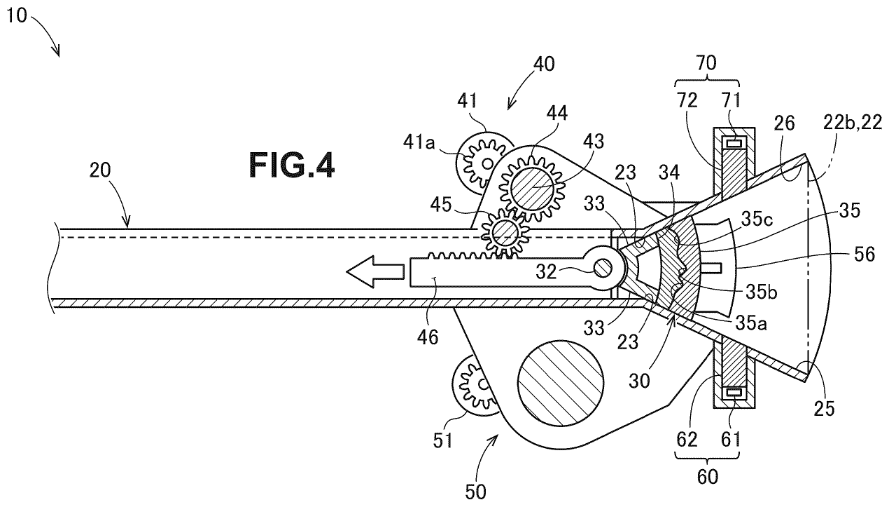

Referring to FIG. 4, when the operation mode is switched from the normal mode to the air-blowing stop mode, the first fin mechanism 40 is operated to displace the fin body 30 toward an upstream side. The fin body 30 comes into contact with the narrow portion 23, so that the flow path is blocked, and the air blowing is stopped. Namely, the air is no longer blown out from the blowout port 22.

When the operation mode is changed from the air-blowing stop mode to the normal mode, the first motor 41 is rotated in reverse. Accordingly, the fin body 30 is displaced toward a downstream side, and the air can be blown into the passenger compartment.

The fin body 30 may be usable at any intermediate position between a position illustrated in the figure and an air-blowing stop position (between a most downstream position and the position where the fin body 30 comes into contact with the narrow portion 23).

In addition, as long as the fin body 30 can block the flow path to stop air blowing, a portion with which the fin body 30 comes into contact may not be the narrow portion 23.

Referring to FIG. 3, when the fin body 30 is in the normal mode, the second fin mechanism 50 can be operated to swing the fin body 30. Depending on the position to which the fin body 30 is directed, the ratio of the blowing air passing above and below the fin body 30 changes, and the direction in which the air is blown is changed.

As described above, in the air-blowing stop mode, the fin body 30 is displaced toward the upstream side. At this time, the fin body 30 is offset with respect to the fin supports 56. Even if the second fin mechanism 50 is operated during the air-blowing stop mode, the fin body 30 does not swing.

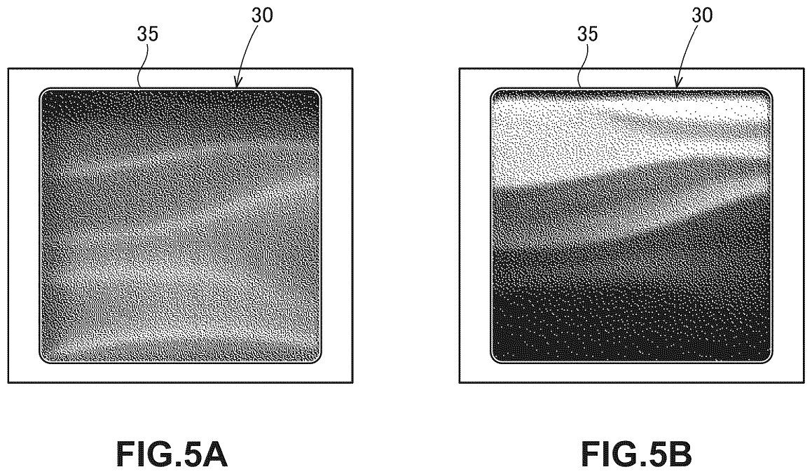

Referring to FIG. 5A, FIG. 5A illustrates a pattern of the ornament 35 that is visible to an occupant (viewer) in the normal mode. As the fin body 30 is displaced to the position in the air-blowing stop mode from this state, the way in which light hits the uneven portions 35a to 35c (see FIG. 2) formed on the ornament 35 changes, and the pattern of the ornament 35 that is visible to the occupant changes as illustrated in FIG. 5B. In addition, as the fin body 30 swings in the second direction, the pattern also appears to change to the occupant.

The air-conditioning outlet device 10 described above will be summarized below.

Referring to FIG. 2, in a first aspect, the air-conditioning outlet device 10 includes the housing 20 into which the air is blown, and in which the blowout port 22 that blows out the air is formed at the downstream end with respect to a flow direction of the blown air; the fin body 30 displaceably provided inside the housing 20; and illumination units 60 and 70 capable of illuminating the downstream end of the fin body 30. The downstream end of the fin body 30 serves as the ornament 35 that is decorated and that is illuminated by the illumination units 60 and 70.

Referring also to FIG. 1, the blowout port 22 has a substantially rectangular shape. When the direction parallel to the long sides 22a of the blowout port 22 is defined as the first direction and the direction parallel to the short sides 22b that are sides shorter than the long sides 22a is defined as the second direction, the fin body 30 is provided along the first direction and is located upstream of the blowout port 22 and substantially at a central position in the second direction in the normal mode to allow the air to be blown.

Referring to FIG. 4, in addition, by being displaced from the position in the normal mode (see FIG. 2) toward the upstream side, the fin body 30 blocks a part of the flow path to set the air-blowing stop mode in which air blowing is prevented.

Referring to FIG. 2, the downstream end of the fin body 30 serves as the ornament 35 that is decorated and that is illuminated by the illumination units 60 and 70. By displacing the fin body 30 along the flow path, switching is performed between the normal mode in which the air can be blown and the air-blowing stop mode in which air blowing is prevented (see FIG. 4). Since the fin body 30 is displaced along the flow path, regardless of whether the fin body 30 is in the position in the normal mode or in the position in the air-blowing stop mode, the ornament 35 is visible from the blowout port 22. Good design can be ensured in both the normal mode and the air-blowing stop mode, and the design of the air-conditioning outlet device 10 can be improved. The air-conditioning outlet device 10 with good design can be provided.

In a second aspect, in the air-conditioning outlet device 10 according to the first aspect, the housing 20 includes the narrow portion 23 having an area narrower than the area of the blowout port 22, and the inner walls 25 and 26 extending from the narrow portion 23 to the blowout port 22 along the fin body 30 are formed inside the housing 20. The blown air can be smoothly guided from the narrow portion 23 to the blowout port 22. In addition, reflected light illuminates the inner walls 25 and 26, so that the effect of indirect illumination can be created.

In a third aspect, in the air-conditioning outlet device 10 according to the first or second aspect, the fin body 30 includes the tapered portions 33 and 33 in which a width in the second direction increases as the tapered portions 33 and 33 extend from the upstream side toward the downstream side, and a width of the fin body 30 in the second direction is smaller than a width of the short sides 22b of the blowout port 22. The flow path from the narrow portion 23 to the blowout port 22 can be ensured without being further narrowed.

When the area of the blowout port 22 is small, the flow speed becomes high at the blowout port 22 located closest to an occupant, and the range where the air hits the occupant is also narrow, so that strong air hits the occupant. The area of the blowout port 22 is not narrowed, the narrow portion 23 is formed on the upstream side, and the air is divided into two airflows between the narrow portion 23 and the blowout port 22 by the fin body 30 (tapered portions 33 and 33). The two divided airflows are blown out from the blowout port 22 in the directions away from each other upward and downward; however, since portions of the two airflows are drawn into the central region, the air spreads and is blown out over a wide range including the central region. Therefore, the strength of the air hitting the occupant can be adjusted to a moderate strength, so that comfort can be improved.

In a fourth aspect, the air-conditioning outlet device 10 according to any one of the first to third aspects further includes the first fin mechanism 40 that displaces the fin body 30 along the air blowing direction. The fin body 30 can be moved to a more accurate position.

In a fifth aspect, in the air-conditioning outlet device 10 according to the fourth aspect, the first fin mechanism 40 includes the first motor 41 that generates a driving force in the rotation direction when energized, the gears 42, 44, and 45 (see FIG. 1 for the gear 42) that rotate when the first motor 41 is operated, and the rack 46 that converts the rotational motion of the gears 42, 44, and 45 into a linear motion and that is connected to the fin body 30. The fin body 30 can be moved to a more accurate position.

Referring to FIG. 3, in a sixth aspect, the air-conditioning outlet device 10 according to any one of the first to fifth aspects further includes the second fin mechanism 50 for displacing the fin body 30 in the second direction. The air blowing direction can be adjusted by displacing the fin body 30 in the second direction.

In a seventh aspect, in the air-conditioning outlet device 10 according to the sixth aspect, the second fin mechanism 50 includes the second motor 51 that generates a driving force in the rotation direction when energized, the gears 52 to 54 that rotate when the second motor 51 is operated, and the fin supports 56 rotatable in conjunction with the gears 52 to 54 and capable of supporting the fin body 30. The fin body 30 can be moved to a more accurate position.

Referring to FIG. 2, in an eighth aspect, in the air-conditioning outlet device 10 according to any one of the first to seventh aspects, the plurality of uneven portions 35a to 35c having different depths are formed on the ornament 35, and as the fin body 30 is displaced along the air blowing direction, the pattern of the ornament 35 that is visible to a viewer changes (see FIG. 5A and FIG. 5B). As the fin body 30 is displaced, the position of the ornament 35 that is illuminated by the illumination units 60 and 70 changes. Since the plurality of uneven portions 35a to 35c having different depths are formed on the ornament 35, as the illuminated position changes, the direction in which light is reflected changes. Accordingly, the pattern appears to have changed to the viewer. Since the pattern changes as the fin body 30 is displaced, the design is further improved. Since the amount of light reflected by the inner walls 25 and 26 also changes, the overall design of the air-conditioning outlet device 10 is improved.

In a ninth aspect, in the air-conditioning outlet device 10 according to any one of the sixth to eighth aspects, the plurality of uneven portions 35a to 35c having different depths are formed on the ornament 35, and as the fin body 30 is displaced along the second direction, the pattern of the ornament 35 that is visible to a viewer changes. As the fin body 30 is displaced, the position of the ornament 35 that is illuminated by the illumination units 60 and 70 changes. Since the plurality of uneven portions 35a to 35c having different depths are formed on the ornament 35, as the illuminated position changes, the direction in which light is reflected changes. Accordingly, the pattern appears to have changed to the viewer. Since the pattern changes as the fin body 30 is displaced, the design is improved. Since the amount of light reflected by the inner walls 25 and 26 also changes, the overall design of the air-conditioning outlet device 10 is improved.

The air-conditioning outlet devices according to the invention may be disposed not only in the front portion of the passenger compartment but may also be provided in a console, a ceiling, pillars, and the like.

The invention is not limited to the embodiment as long as the actions and effects of the invention are exhibited.

What is claimed is:

1. An air-conditioning outlet device comprising:
a housing into which air is blown, and in which a blowout port that blows out the air is formed at a downstream end with respect to a flow direction of the blown air;
a fin body displaceably provided inside the housing; and
illumination units capable of illuminating a downstream end of the fin body,
wherein the downstream end of the fin body serves as an ornament that is decorated and that is illuminated by the illumination units,
the blowout port has a substantially rectangular shape, and
when a direction parallel to long sides of the blowout port is defined as a first direction and a direction parallel to short sides that are sides shorter than the long sides is defined as a second direction, the fin body is provided along the first direction and is located upstream of the blowout port and substantially at a central position in the second direction in a normal mode to allow the air to be blown, and by being displaced from a position in the normal mode toward an upstream side, the fin body blocks a part of a flow path to set an air-blowing stop mode in which air blowing is prevented.

2. The air-conditioning outlet device according to claim 1,
wherein the housing includes a narrow portion having an area narrower than an area of the blowout port, and
inner walls extending from the narrow portion to the blowout port along the fin body are formed inside the housing.

3. The air-conditioning outlet device according to claim 1,
wherein the fin body includes tapered portions in which a width in the second direction increases as the tapered portions extend from the upstream side toward a downstream side, and a width of the fin body in the second direction is smaller than a width of the short sides of the blowout port.

4. The air-conditioning outlet device according to claim 1, further comprising:
a first fin mechanism that displaces the fin body along an air blowing direction.

5. The air-conditioning outlet device according to claim 4,
wherein the first fin mechanism includes a first motor that generates a driving force in a rotation direction when energized, gears that rotate when the first motor is operated, and a rack that converts the rotational motion of the gears into a linear motion and that is connected to the fin body.

6. The air-conditioning outlet device according to claim 4, further comprising:
a second fin mechanism for displacing the fin body in the second direction.

7. The air-conditioning outlet device according to claim 6,
wherein the second fin mechanism includes a second motor that generates a driving force in a rotation direction when energized, gears that rotate when the second motor is operated, and a fin support rotatable in conjunction with the gears and capable of supporting the fin body.

8. The air-conditioning outlet device according to claim 1,
wherein a plurality of uneven portions is formed on the ornament, and
as the fin body is displaced along an air blowing direction, a pattern of the ornament that is visible to a viewer changes.

9. The air-conditioning outlet device according to claim 6,
wherein a plurality of uneven portions is formed on the ornament, and
as the fin body is displaced along the second direction, a pattern of the ornament that is visible to a viewer changes.
